(19) United States
(12) Patent Application Publication
(10) Pub. No.: US 2023/0368264 A1
(43) Pub. Date: Nov. 16, 2023

(54) MACHINE LEARNING RECOMMENDATION ENGINE WITH IMPROVED COLD-START PERFORMANCE

(71) Applicant: Accenture Global Solutions Limited, Dublin (IE)

(72) Inventors: Piyush Vakil, Bartlett, IL (US); Abhishek ad Gupta, Gurugram (IN); Patrick Christopher Ahern, Chicago, IL (US); Mohit E. Jain, Gurugram (IN); Vlad D. Kucherovsky, Overland Park, KS (US); Saumya Kharya, Pune (IN)

(21) Appl. No.: 17/742,531

(22) Filed: May 12, 2022

(51) Int. Cl. G06Q 30/06; G06K 9/62; G06N 20/00

(52) U.S. Cl. CPC G06Q 30/0631; G06Q 30/0605; G06K 9/6256; G06N 20/00

(57) ABSTRACT

Implementations are directed to obtaining a plurality of item profiles for a plurality of new items, each item profile comprising a set of attributes for a respective new item; for each new item: selecting one or more existing items that are similar to the new item based on item attributes of the existing items and the set of attributes of the new item, and executing a collaborative filtering model to determine a first score for the new item based on historical user interactions with the one or more existing items; determining a second score for each new item using an adaptive model; and outputting a first set of new items based on the first score, and a second set of new items based on the second score, an initial ratio between the first set of new items and the second set of new items is a predetermine value.

### BACKGROUND

It is important to make recommendations that may be beneficial or of interest to users. To this end, recommendation systems have been developed. Some traditional recommendation systems are provided as self-learning systems to provide one or more recommendations based on user preferences. However, such traditional recommendation systems suffer from technical disadvantages. For example, such traditional recommendation systems can have a cold-start problem. The cold-start problem occurs when a self-learning algorithm or system does not have sufficient customer interactions with which to train itself. For instance, when new items (e.g., goods, or services, or any other objects) are added into the system, the traditional recommendation system may not have sufficient information or user interaction data on such new items. The traditional recommendation system may make poor recommendations for the new items due to the lack of training data. Furthermore, it can take a long time for the traditional recommendation system to gather sufficient user interaction training data for the new items to improve the prediction accuracy.

### SUMMARY

Implementations of the present disclosure are generally directed to a hybrid method, where a collaborative filtering model can supplement an adaptive model for an initial period of time. The collaborative filtering model is used as a solution to the cold-start problem faced by the traditional self-learning systems. More particularly, the collaborative filtering model can use customer preferences, past actions and customer similarity to predict the most relevant actions/items. The collaborative filtering model can use historical user interactions with existing items that are similar to a new item to predict a score for the new item. The existing items that are similar to a new item can be determined based on an adjusted cosine similarity between each existing item and the new item. The predicted score can indicate an acceptance level of the new item. The techniques described in this document can make recommendations for new items based on the predicted scores.

After making the recommendations for new items, a computing system can collect user interactions to the new items. Such user interactions to the new items can be used as training data for an adaptive model. For example, after collecting sufficient user interaction data to the new items, the computing system can train the adaptive model to make real-time predictions for users. After a certain period of time, the computing system can make recommendations for new items only using the adaptive model. For instance, when the accuracy of the adaptive model satisfies a threshold, the computing system can solely rely on the adaptive model for recommendation of the new items.

The techniques described in this document can enhance the adaptive model by giving the adaptive model a warm-start. The learning of the adaptive model can start at an accelerated pace at the onset. By using the collaborative filtering model for an initial period of time, the techniques described in this document can mitigate the cold-start problem faced by traditional self-learning systems.

In some implementations, the techniques described in this document can be used to make demand forecast. Because the adaptive model can start at an accelerated pace with a warm-start, the adaptive model can make more accurate recommendations or predictions on new items, that are likely to be accepted by users, with less training time. The adaptive model can forecast the demand on the new items ahead of time. Based on the demand forecast, manufactures can adjust their timelines or producing procedures to better meet the forecasted demand on the new items. In some examples, the techniques described herein can use the recommendation results and user interactions to output a set of variables. The set of variables can be used to control operations of the manufactures or any other relevant entities.

In some implementations, the techniques described in this document can be used to improve healthcare services. For example, a chatbot can be developed using this proprietary algorithm in the backend to assist end-users when searching for solutions online using symptoms as in input. The chatbot developed using the techniques described herein can offer a better personalization that increases the details of provided recommendations and improves users' understanding of their medical condition. The chatbot can analyze patients' health status and recommend personalized diets, exercise routines, medications, disease diagnoses, or other healthcare services.

In some implementations, the techniques described in this document can use medical resources to assist healthcare professionals in creating more precise suggestions for patients. For each recommendation scenario, recommendation algorithms can be summarized and corresponding working examples can be developed. The techniques described herein can help to reduce time to diagnosis, which can help healthcare professionals for developing a streamlined prognosis for patients. This can lead to cost-effective and simplified tests/diagnostic procedures, reducing effort and investigative checkups at the initial stages.

In some implementations, the techniques described in this document can be used in creation of medicines. For example, the techniques described herein can recommend bond substitutions based on a known condition and a previous group of known medicines. In some examples, the techniques described herein can recommend a drug or therapy based on a known condition and a set of possible treatment paths.

In some implementations, the techniques described in this document can be used in engineering field, e.g., recommending a material to repair a damaged structure. For instance, based on historical data that includes the type of materials for repairing different damaged structures, the techniques described herein can recommend one or more particular materials for a particular damaged structure.

In some implementations, actions can include obtaining a plurality of item profiles for a plurality of new items, each item profile comprising a set of attributes for a respective new item; for each new item in the plurality of new items: selecting one or more existing items that are similar to the new item based on item attributes of the one or more existing items and the set of attributes of the new item, and executing a collaborative filtering model to determine a first score for the new item based on historical user interactions with the one or more existing items; determining a second score for each new item in the plurality of new items using an adaptive model; and outputting a first set of new items based on the first score, and a second set of new items based on the second score, wherein an initial ratio between the first set of new items and the second set of new items is a predetermine value.

Other implementations of this aspect include corresponding systems, apparatus, and computer programs, configured to perform the actions of the methods, encoded on computer storage devices.

These and other implementations can each optionally include one or more of the following features, alone or in combination. In some implementations, the actions can include determining a first accuracy based on user interactions to the first set of new items and a second accuracy based on user interactions to the second set of new items; and in response to determining that an accuracy ratio between the first accuracy and the second accuracy satisfies a threshold, outputting new items only using the adaptive model. In some implementations, the second accuracy corresponds to the adaptive model and the second accuracy increases during an iterative process.

In some implementations, the actions can include in an iterative process: collecting user interactions to the first set of new items and the second set of new items; training the adaptive model using the user interactions to the first and the second set of new items; updating the second score for each new item using the trained adaptive model; and updating and outputting the first set of new items and the second set of new items based on the first score and the updated second score. In some implementations, a ratio between the updated first set of new items and the updated second set of new items is less than the initial ratio.

In some implementations, training the adaptive model using the user interactions to the first and the second set of new items in the iterative process can include: for a threshold number of iterations, collecting user interactions to the first set of new items and the second set of new items; and training the adaptive model using the user interactions collected in the threshold number of iterations.

In some implementations, the one or more existing items can be selected based on an adjusted cosine similarity. In some implementations, the adjusted cosine similarity can be determined based on the set of attributes of the new item, the item attributes of the one or more existing items, and historical user interactions to the one or more existing items.

In some implementations, the new item can include one of a new item and a new action.

It is appreciated that methods in accordance with the present disclosure can include any combination of the aspects and features described herein. That is, for example, apparatus and methods in accordance with the present disclosure are not limited to the combinations of aspects and features specifically described herein, but also may include any combination of the aspects and features provided.

The details of one or more implementations of the present disclosure are set forth in the accompanying drawings and the description below. Other features and advantages of the present disclosure will be apparent from the description, drawings, and claims.

### BRIEF DESCRIPTION OF DRAWINGS

FIG. 1 depicts an example system that can execute implementations of the present disclosure.

FIG. 2 depicts a representation of different stages of a recommendation process in accordance with implementations of the present disclosure.

FIG. 3 depicts an example process of making recommendations for new items that can be executed in accordance with implementations of the present disclosure.

FIG. 4 depicts an example process for a recommendation system transitioning to an adaptive model in an iterative process in accordance with implementations of the present disclosure.

FIG. 5 depicts an example process representing a recommendation workflow in accordance with implementations of the present disclosure.

Like reference numbers and designations in the various drawings indicate like elements.

### DETAILED DESCRIPTION

Implementations of the present disclosure are generally directed to a hybrid method, where a collaborative filtering model can supplement an adaptive model for an initial period of time. The collaborative filtering model is used as a solution to the cold-start problem faced by the traditional self-learning systems. More particularly, the collaborative filtering model can use customer preferences, past actions and customer similarity to predict the most relevant items. The collaborative filtering model can use historical user interactions with existing items that are similar to a new item to predict a score for the new item. The predicted score can indicate an acceptance level of the new item. The techniques described in this document can make recommendations for new items based on the predicted scores.

After making the recommendations for new items, a computing system can collect user interactions to the new items. Such user interactions to the new items can be used as training data for an adaptive model. For example, after collecting sufficient user interaction data to the new items, the computing system can train the adaptive model to make real-time predictions for users. After a certain period of time, the computing system can make recommendations for new items only using the adaptive model. For instance, when the accuracy of the adaptive model satisfies a threshold, the computing system can solely rely on the adaptive model for recommendation of the new items.

The techniques described in this document can enhance the adaptive model by giving the adaptive model a warm-start. The learning of the adaptive model can start at an accelerated pace at the onset. By using the collaborative filtering model for an initial period of time, the techniques described in this document can mitigate the cold-start problem faced by traditional self-learning systems.

In some implementations, actions can include obtaining a plurality of item profiles for a plurality of new items, each item profile comprising a set of attributes for a respective new item; for each new item in the plurality of new items: selecting one or more existing items that are similar to the new item based on item attributes of the one or more existing items and the set of attributes of the new item, and executing a collaborative filtering model to determine a first score for the new item based on historical user interactions with the one or more existing items; determining a second score for each new item in the plurality of new items using an adaptive model; and outputting a first set of new items based on the first score, and a second set of new items based on the second score, wherein an initial ratio between the first set of new items and the second set of new items is a predetermine value.

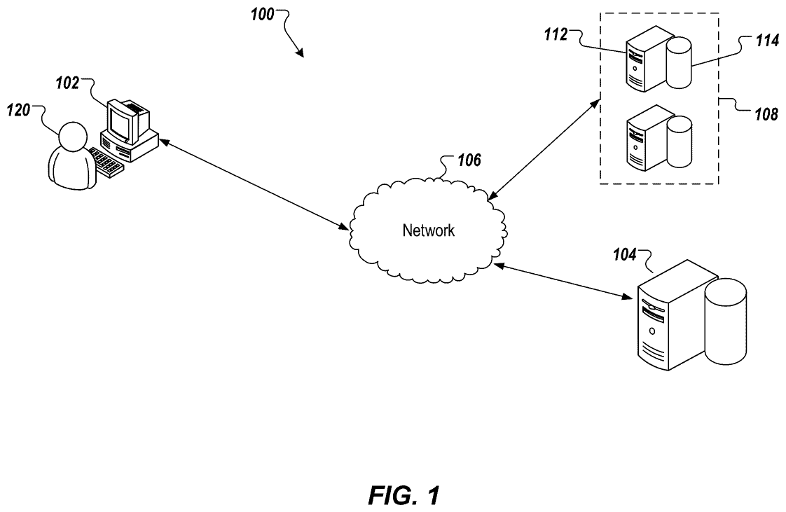

FIG. 1 depicts an example system 100 that can execute implementations of the present disclosure. The example system 100 includes a user device 102, an item provider device 104, a back-end system 108, and a network 106. In some examples, the network 106 includes a local area network (LAN), wide area network (WAN), the Internet, or a combination thereof, and connects web sites, devices (e.g., the user device 102, the item provider device 104), and back-end systems (e.g., the back-end system 108). In some examples, the network 106 can be accessed over a wired and/or a wireless communication link.

In some examples, the user device 102 can include any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices.

In some examples, the item provider device 104 can be any electronic device that is capable of communicating over the network 106. In some implementations, the item provider device 104 corresponds to an organization that provides items, such as products, services, functions, actions, or information, to users. For example, the item provider device 104 can provide items to users 120 of the user devices 102. The item provider device 104 can maintain user data for users that use the items provided by the item provider device 104. For instance, the item provider device 104 can maintain user data for users that previously registered with the item provider device 104. The item provider device 104 can also maintain historical user interaction data with the existing items provided by the item provider device 104. The historical user interaction data can include user reviews, user purchases, user ratings, user preferences, and the like, for the existing items. The item provider device 104 can also maintain item data for the items provided by the item provider device 104. The item data can include the item profile for each item. Each item profile can include a set of attributes for a respective item. The item provider device 104 can predict items that a user 120 would like to purchase and recommend such items to the user 120.

In some examples, the item provider device 104 can provide new items. The new items can be new-to-market products or services, or new functions of existing items, or new actions, or new information, or the like. The new items may not have any user interactions on them when they are first developed and added into the market, which can make the recommendation of these new items difficult. In some implementations, the item provider device 104 can request the back-end system 108 to make recommendations on the new items.

In the depicted example of FIG. 1, the back-end system 108 includes at least one server system 112, and data store 114 (e.g., database). In some examples, the at least one server system 112 hosts one or more computer-implemented services (e.g., recommendation services) in accordance with implementations of the present disclosure. The back-end system 108 is also referred to as a recommendation system.

In some implementations, the back-end system 108 can be a separate recommendation system that communicates with the item provider device 104 and helps the item provider device 104 to make recommendations on the new items. In some implementations, the back-end system 108 and the item provider device 104 can be the same system. For instance, the item provider device 104 can include a recommendation system (e.g., the back-end system 108) for making recommendations on new items.

Implementations of the present disclosure are described in further detail herein with reference to an example use case that includes recommending new items to customers/users. The new items can be new-to-market products or services, new functions, new actions, new information, and the like. For example, the recommendation system described in this document can be used to predict or recommend new items that are most likely to be preferred by customers/users. It is contemplated, however, that implementations of the present disclosure can be applied in any appropriate use case.

More specifically, the back-end system 108 can receive a request for making recommendations on new items, from the item provider device 104 over the network 106. The back-end system 108 can receive or obtain the item profiles for each new item. The item profile can include a set of attributes for a respective new item. The back-end system 108 can receive or obtain the item attributes of existing items and historical user interaction data on the existing items. The back-end system 108 can make recommendations using the item profile of each new item, the item attributes of existing items, and the historical user interaction data, as described in further detail herein. The back-end system 108 can use a collaborative filtering model, or an adaptive model, or both to process the data and make recommendations.

In some examples, the back-end system 108 can return the recommended new items to the item provider device 104. The item provider device 104 can provide the recommended new items to the user device 102 for display. In some examples, the back-end system 108 can directly provide the recommended new items to the use device 102 for display. A user 120 can choose to interact with a recommended new item or not. For instance, the user can choose to accept the recommended new item, such as purchasing the recommended product or service. In some examples, the back-end system 108 can receive the user interaction data on the recommended new items thought the item provider device 104. In some examples, the back-end system 108 can obtain the user interaction data directly. The back-end system 108 can use such user interaction data as training data to train the adaptive model.

In some examples, the server system 112 can store the item profile of each new item, the item attributes of existing items, the historical user interaction data, and the collected user interactions on the recommended new items in the data store 114. The server system 112 can also retrieve those data from the data store 114. The data store 114 can include any other information necessary for performing the functions described herein. For example, the data store 114 can store threshold values for configuring the recommendation system and other parameters used in the collaborative filtering model and the adaptive model.

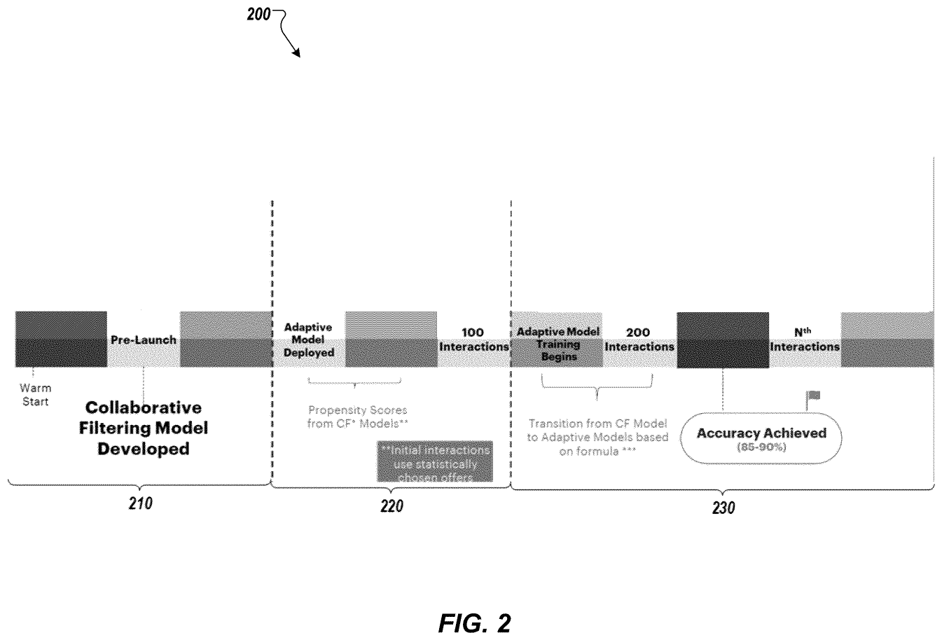

FIG. 2 depicts a representation of different stages of a recommendation process 200 in accordance with implementations of the present disclosure. The recommendation process 200 can be implemented by the back-end system 108 (e.g., recommendation system) shown in FIG. 1. In some examples, the recommendation process 200 is provided using one or more computer-executable programs executed by one or more computing devices.

In a pre-launch stage 210, the recommendation system can develop a collaborative filtering model to make recommendations for new items. The new items may not have any user interactions on them when they are first developed and added into the market, which can make the recommendation of these new items difficult. The recommendation system described in this document can use the historical user interactions with existing items that are similar to the new items to make predictions about the new item. This can provide a warm start for the new item recommendations and address the cold-start problem faced by traditional self-learning systems. For each new item, the recommendation system can execute the collaborative filtering model to determine a first recommendation score for the new item based on the historical user interactions with the one or more existing items.

In the next stage 220, the recommendation system can deploy the adaptive model. However, the training of the adaptive model may not begin until a threshold number of interactions are executed. The recommendation system can make recommendations of the new items using the collaborative filtering model and collect the user interactions to the recommended new items. The recommendation system can collect such user interactions for a threshold number of interactions. For example, the recommendation system can collect the user interactions to the new items, recommended using the collaborative filtering model, for 100 interactions. The training of the adaptive model can start after 100 interactions data are collected.

In the next stage 230, the training of the adaptive model can start. For example, the training of the adaptive model can start after 100 interactions data are collected and used as training data of the adaptive model. The recommendation system can use both the collaborative filtering model and the adaptive model for an initial period of time and then make transition to only using the adaptive model. For example, during the initial period of time, such as during the 101-200 interactions, the recommendation system can keep outputting recommended new items using both models, and collecting user interactions to the recommended new items iteratively. In each iteration, the recommendation system can output a first set of new item recommendations using the collaborative filtering model and a second set of new item recommendations using the adaptive model. In each iteration, the recommendation system can collect the user interactions for those new items. The recommendation system can add newly collected user interaction data to the training data and retrain the adaptive model. Because the adaptive model is retrained during the iterative process based on more available training data, the prediction accuracy of the retrained adaptive model increases during the iterative process. When the prediction accuracy of the adaptive model satisfies a certain threshold or condition, the recommendation system can only use the adaptive model for future recommendations on new items. For instance, when the prediction accuracy of the adaptive model is larger than the prediction accuracy of the collaborative filtering model, the recommendation system can transition to only using the adaptive model. In the example shown in FIG. 2, after 200 interactions, the recommendation system can make the transition of only using the adaptive model which can achieve an accuracy of 85%-90% in this example.

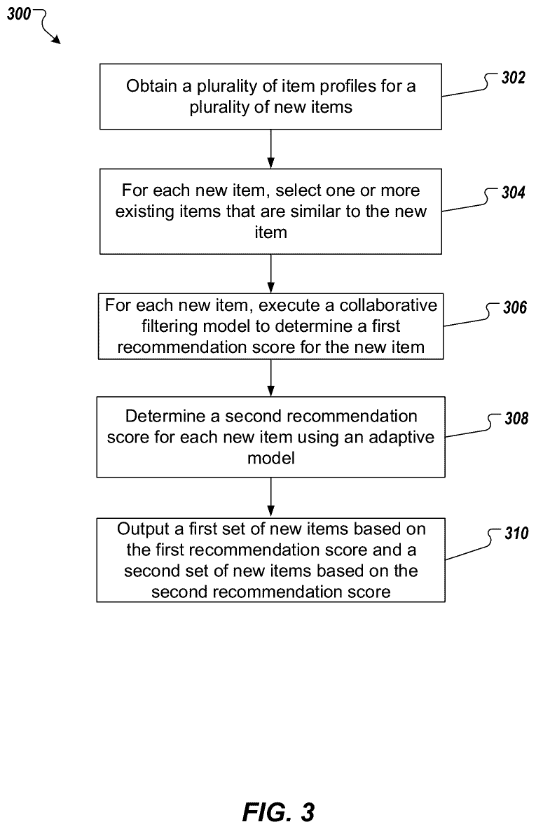

FIG. 3 depicts an example process 300 of making recommendations for new items that can be executed in accordance with implementations of the present disclosure. The example process 300 can be implemented by the back-end system 108 (e.g., recommendation system) shown in FIG. 1. In some examples, the example process 300 is provided using one or more computer-executable programs executed by one or more computing devices.

At step 302, the recommendation system obtains a plurality of item profiles for a plurality of new items. Each item profile can include a set of attributes for a respective new item.

The new items can be new-to-market products or services, or new functions of existing items, or new actions. The new items may not have any user interactions on them when they are first developed and added into the market. The recommendation system can obtain the item profiles for the new items. The item profile for a new item can include the attributes of the new item. For example, if the new item is a dress, the item profile for the dress can include the attributes of the dress, such as the price, the color, the sleeve length, the collar type, the material, the style, and the like.

At step 304, for each new item in the plurality of new items, the recommendation system can select one or more existing items that are similar to the new item based on item attributes of the one or more existing items and the set of attributes of the new item.

As discussed above, the new items may not have any user interactions on them when they are first developed, which can make the recommendation of these new items difficult. The recommendation system described in this document can use the historical user interactions with existing items that are similar to the new items to determine an acceptance level for each new item.

For example, for each new item, the recommendation system can determine a similarity level between an existing item and the new item. In some implementations, the recommendation system can obtain the item attributes of the existing item. The recommendation system can determine a cosine similarity between the item attributes of the existing item and the set of attributes of the new item. Based on the cosine similarity, the recommendation system can determine a set of existing items with the highest similarity levels. In some examples, the recommendation system can select the set of existing items whose cosine similarities with the new item satisfy a threshold value. In some examples, the recommendation system can select the set of existing items by selecting a predetermine number of existing items, such as top N existing items whose cosine similarities are the highest.

After determining the set of existing items whose attributes are most similar to the new item, the recommendation system can further adjust the cosine similarity based on historical user interactions with the set of existing items. User interactions can include user reviews, user purchases, user ratings, user preferences, and the like, for the existing items. To determine the adjusted cosine similarity, the recommendation system can consider both the similarity in terms of the item attributes and the historical user interactions. The adjusted cosine similarity between a new item and an existing item can be determined based on the set of attributes of the new item, the item attributes of the existing item, and historical user interactions with the existing item. For example, the existing items with more user interaction data may have a higher value of adjusted cosine similarity. The user interaction data for an existing item can include interactions or actions between users and the existing item, such as the number of views, conversions, purchases, the number of clicks, event rate, and the like.

Among the set of existing items, the recommendation system can select one or more existing items based on the adjusted cosine similarities. In some examples, the recommendation system can select the one or more existing items whose adjusted cosine similarities with the new item satisfy a threshold value. In some examples, the recommendation system can select the one or more existing items by selecting a predetermine number of existing items, such as top N existing items whose adjusted cosine similarities are the highest, wherein N can be one or any other integer value that is larger than one.

At step 306, for each new item, the recommendation system can execute a collaborative filtering model to determine a first recommendation score for the new item based on the historical user interactions with the one or more existing items. The first recommendation score can indicate a likelihood of the new item being accepted by users, which is determined by the collaborative filtering model.

The selected one or more existing items are the most similar to the new item and have received historical user interactions. The recommendation system can use such historical user interaction data to predict the acceptance level for the new item. Even though the new item has no user interaction data available when first developed, the recommendation system can use historical user interaction data for similar existing items to make predictions about the new item. This can address the cold-start problem faced by traditional self-learning systems.

The recommendation system can execute a collaborative filtering model to determine the recommendation score for the new item, based on the historical user interactions with the one or more existing items. The collaborative filtering model can make automatic predictions (filtering) about the interests of a user by collecting preferences or taste information from many users (collaborating). The collaborative filtering model can include neighborhood methods and latent factor methods. The neighborhood methods can compute the relationships between items or between users. The latent factor methods can explain the ratings by charactering both items and users on many factors inferred from the rating pattern.

The collaborative filtering model can include a matrix factorization algorithm for calculating the recommendation scores. The matrix factorization can decompose user-item interaction matrix into the product of two lower dimensionality rectangular matrices. One matrix can be the user matrix where rows represent users and columns are latent factors. The other matric is the item matrix where rows are latent factors and columns represent items.

At step 308, the recommendation system can determine a second recommendation score for each new item in the plurality of new items using an adaptive model. The second recommendation score can indicate a likelihood of the new item being accepted by users, which is determined by the adaptive model.

The adaptive model can evolve with changing contexts provided during the modeling process. The adaptive model can predict outcomes for items based on users' real-time behaviors. The recommendation system described in this document can collect user interactions to the new items and use such user interaction data to train the adaptive model. For an initial period of time (e.g., a certain period after the new items are first released), the recommendation system may not be able to collect sufficient user interaction data for the new items to train the adaptive model. In some implementations, during the initial period of time, the adaptive model may make recommendations for new items with less accuracy. As more user interaction data regarding the new items becoming available, the recommendation system can continuously train the adaptive model to improve the prediction accuracy of the adaptive model.

In some implementations, the training of the adaptive model does not begin until a threshold number of interactions are executed. For example, the recommendation system can make recommendations of the new items, and collect the user interactions to the recommended new items. The recommendation system can collect such user interactions for a threshold number of interactions. The recommendation system can start the training of the adaptive model after collecting the user interactions in the threshold number of iterations. For example, the training of the adaptive model can start after 100 interactions data are collected and used as training data of the adaptive model. In some implementations, the adaptive model may not make recommendations for the threshold number of interactions. In those threshold number of interactions, the recommendation system may make recommendations for the new items using the collaborative filtering model based on historical user interactions with similar existing items, as discussed above.

At step 310, the recommendation system can output a first set of new items based on the first recommendation score for each new item and a second set of new items based on the second recommendation score for each new item. An initial ratio between the first set of new items and the second set of new items can be a predetermined value.

As discussed above, for the initial period of time, the recommendation system may not have sufficient training data to fully train the adaptive model. The prediction accuracy of the adaptive model may not be satisfactory. The recommendation system can mainly use prediction results of the collaborative filtering model, e.g., the first set of new items based on the first recommendation score, in the initial period of time. The recommendation system can use a small portion of the prediction results of the adaptive model, e.g., the second set of new items, based on the second recommendation score.

The initial ratio between the first set of new items and the second set of new items can be a predetermined value. The initial ratio can determine how much the recommendation system relies on the collaborative filtering model and the adaptive model. The recommendation system relies on the collaborative filtering model more heavily during the initial period of time, due to the low prediction accuracy of the adaptive model. For example, recommendations generated by the recommendation system can include interactions with different users. The recommendation system can initially have a 90% chance using the prediction results generated by the collaborative filtering model as the recommendation results to the user; and a 10% chance using the prediction results generated by the adaptive model as the recommendation results to the user. As a result, assume that the recommendations include 100 interactions with different users, about 90 interactions will include prediction results generated by the collaborative filtering model, and about 10 interactions will include prediction results generated by the adaptive model. The initial chance of using the collaborative filtering model or the adaptive model for recommendation can be flexible and configurable. In another example, the recommendation system can initially have a 95% chance using the collaborative filtering model and a 5% chance using the adaptive model to make recommendations in each interaction. The initial ratio can depend on the particular use case of the recommendation. For example, the initial ratio configured in a system for recommending new clothing products may be different from the initial ratio configured in a systems for recommending new healthcare products.

As more user interaction data with the new items becoming available, the recommendation system can continuously train the adaptive model to improve the prediction accuracy of the adaptive model. The recommendation system can slowly make the transition to relying on the adaptive model more heavily.

The order of steps in the process 300 described above is illustrative only, and the process 300 can be performed in different orders. In some implementations, the process 300 can include additional steps, fewer steps, or some of the steps can be divided into multiple steps.

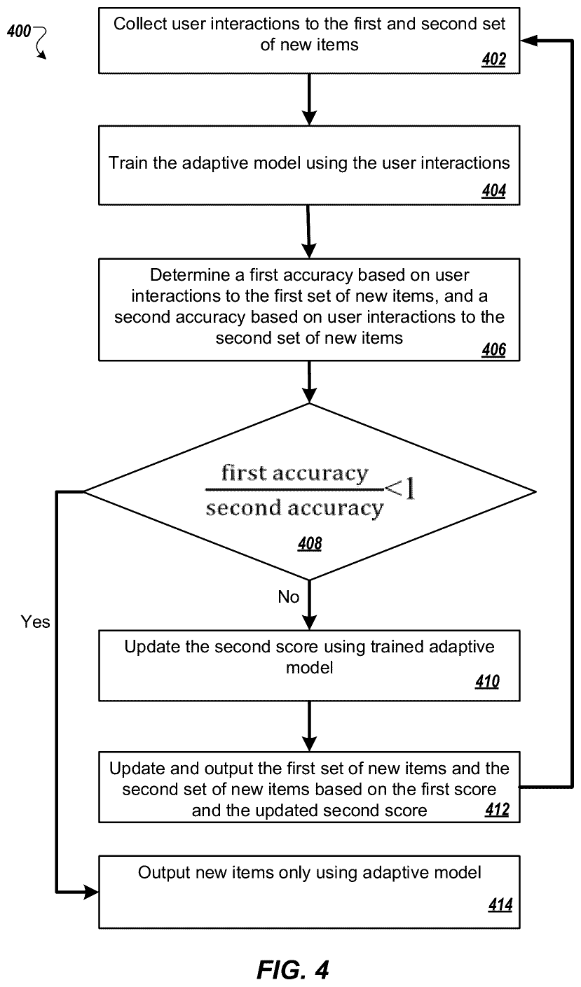

FIG. 4 depicts an example process 400 for the recommendation system transitioning to the adaptive model in an iterative process in accordance with implementations of the present disclosure. The example process 400 can be implemented by the back-end system 108, e.g., recommendation system, shown in FIG. 1. In some examples, the example process 400 is provided using one or more computer-executable programs executed by one or more computing devices.

At step 402, the recommendation system can collect user interactions to the first set of new items and the second set of new items.

As discussed above, during the initial period of time, the recommendation system can output the first set of new item recommendations using the collaborative filtering model and the second set of new item recommendations using the adaptive model. The recommendation system can collect user interactions to the first and the second set of new items. For example, whether the recommended new items have been accepted by users, e.g., purchased, preferred, and the like. Such collected user interaction data is for the new items and can be used for training the adaptive model to make real-time predictions.

At step 404, the recommendation system can train the adaptive model using the user interactions to the first and second set of new items.

During the iterative process, the recommendation system can keep outputting the recommended new items, and collecting the user interactions. For example, in each iteration, the recommendation system can make a set of new item recommendations and collect the user interactions for those new items. The recommendation system can add newly collected user interaction data to the training data and retrain the adaptive model. In some implementations, the recommendation system can retrain the adaptive model in every iteration. In some implementations, the recommendation system can retrain the adaptive model less frequently. For instance, the recommendation system can retrain the adaptive model in every predetermined number of iterations, e.g., in every five iterations. Because the adaptive model is retrained during the iterative process based on more available training data, e.g., user interactions on the new items, the prediction accuracy of the retrained adaptive model increases during the iterative process.

At step 406, the recommendation system can determine a first accuracy based on the user interactions to the first set of new item and a second accuracy based on user interactions to the second set of new items.

In each iteration, after collecting the user interactions to the recommended new items, the recommendation system can determine the prediction accuracy for the collaborative filtering model and the adaptive model. As discussed above, the recommendation system outputs the first set of new items based on the recommendation score of the collaborative filtering model; the second set of new items based on the recommendation score of the adaptive model. The first accuracy based on the first set of new items corresponds to the prediction accuracy of the collaborative filtering model. The second accuracy based on the second set of new items corresponds to the prediction accuracy of the adaptive model.

The prediction accuracy can be determined based on the number of recommended new items that are accepted over the total number of recommended new items. For example, the first accuracy can be determined based on the number of recommended new items in the first set of new items that are accepted over the total number of new items in the first set of new items. The second accuracy can be determined based on the number of recommended new items in the second set of new items that are accepted over the total number of the new items in the second set of new items.

At step 408, the recommendation system can determine whether a ratio between the first accuracy and the second accuracy satisfies a threshold.

As discussed above, the first accuracy corresponds to the collaborative filtering model, the second accuracy corresponds to the adaptive model. During the iterative process, the prediction accuracy of the adaptive model increases with more training data becoming available. The recommendation system can make transition to the adaptive model, as the adaptive model becomes more accurate.

The recommendation system can compare the accuracy of the collaborative filtering model and the accuracy of the adaptive model using an accuracy ratio. The accuracy ratio is between the accuracy of the collaborative filtering model and the accuracy of the adaptive model using an accuracy ratio. The accuracy ratio is compared with a threshold. Based on whether the accuracy ratio satisfies the threshold, the recommendation system can determine whether to use both the collaborative filtering model and the adaptive model in the next iteration or to solely use the adaptive model in the next iteration. For example, the accuracy ratio is compared with the threshold value “1.” If the accuracy ratio is less than 1, the process proceeds to step 414; otherwise the process proceeds to step 410.

At step 410, the recommendation system can update the second score for each new item using the trained adaptive model. If the accuracy ratio is not less than one, the first accuracy is equal to or larger than the second accuracy. In other words, the accuracy of the collaborative filtering model is equal to or larger than the accuracy of the adaptive model. Because the accuracy of the adaptive model is not higher than the accuracy of the collaborative filtering model, the recommendation system can keep using both models. As discussed above, the adaptive model is retrained based on more training data including the newly collected user interaction data. The recommendation system can update the second recommendation score for each new item using the retrained adaptive model.

At step 412, the recommendation system can update and output the first set of new items and the second set of new items based on the first score and the updated second score. A ratio between the updated first set of new items and the updated second set of new items is less than the initial ratio.

In each iteration, the recommendation system can retrain the adaptive model and make new recommendations. To make new recommendations, the recommendation system can update and output the first set of new items based on the first recommendation score of the collaborative filtering model. For example, the recommendation system can output another first set of new items using the collaborative filtering model. The recommendation system can update and output the second set of new items based on the updated second recommendation score of the retrained adaptive model. For example, the recommendation system can output another second set of new items using the retrained adaptive model.

The ratio between the updated first set of new items and the updated second set of new items can determine how much the recommendation system relies on the collaborative filtering model and the adaptive model. As the prediction accuracy of the retrained adaptive model becomes more satisfactory, the recommendation system can use a larger portion of the prediction results of the adaptive model (e.g., the updated second set of new items). During the iterative process, the ratio between the updated first set of new items and the updated second set of new items can decrease, as the recommendation system use more recommendation results from the adaptive model. For example, based on the initial ratio, the recommendation system can initially have a 90% chance using the collaborative filtering model and a 10% chance using the adaptive model to make recommendations in each interaction. After retraining the adaptive model, the recommendation system can have an 85% chance using the collaborative filtering model and a 15% chance using the adaptive model to make recommendations in each interaction.

In some implementations, to rely on the adaptive model more heavily, the recommendation system can increase the proportion of the second set of new items that are determined by the adaptive model. The increase step of the proportion of the second set of new items can be based on the prediction accuracy of the adaptive model. For example, if the adaptive model provides a high prediction accuracy, the proportion of the second set of new items in the recommended results can increase more rapidly.

After step 412, the process proceeds to step 402 for the next iteration, where the recommendation system collects user interactions to the updated first and second set of new items.

At step 414, the recommendation system can output new items only using the adaptive model. If the accuracy ratio is less than one, the first accuracy is smaller than the second accuracy. In other words, the accuracy of the collaborative filtering model is less than the accuracy of the adaptive model. Because the accuracy of the retrained adaptive model provides a higher accuracy, the recommendation system can transition to the adaptive model. The recommendation system can output new items only using the retrained adaptive model to make future recommendations for the new items.

The order of steps in the process 400 described above is illustrative only, and the process 400 can be performed in different orders. In some implementations, the process 400 can include additional steps, fewer steps, or some of the steps can be divided into multiple steps.

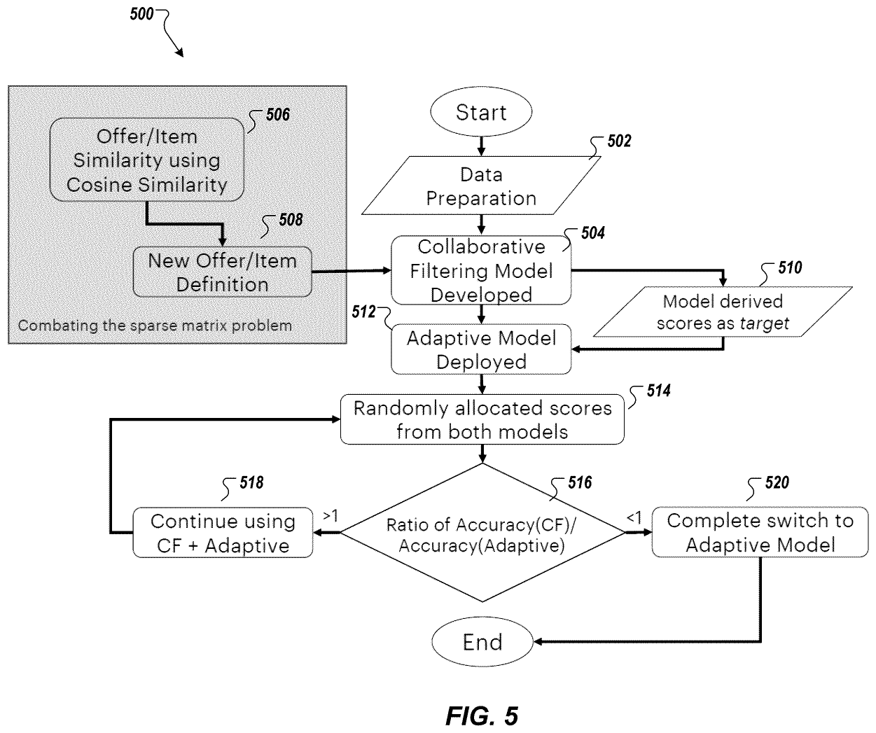

FIG. 5 depicts an example process 500 representing a recommendation workflow in accordance with implementations of the present disclosure. The example process 500 can be implemented by the back-end system 108 (e.g., recommendation system) shown in FIG. 1. In some examples, the example process 500 is provided using one or more computer-executable programs executed by one or more computing devices.

The workflow starts with data preparation 502. In some examples, the data preparation 502 can include receiving the new items, obtaining a set of attributes of the new items. The data preparation 502 can also include obtaining existing items, the item attributes of the existing items, and the historical user interaction data on the existing items.

After data preparation 502, the recommendation system can use a developed collaborative filtering model 504 to make recommendations for new items. For each new item, the recommendation system can determine a cosine similarity between the item attributes of the existing item and the set of attributes of the new item. Based on the cosine similarity, the recommendation system can determine a set of existing items 506 that are most similar to the new item 508 (e.g., the existing items with the highest cosine similarities). The recommendation system can further adjust the cosine similarity based on historical user interactions with the set of existing items. Among the set of existing items, the recommendation system can select one or more existing items based on the adjusted cosine similarities. The recommendation system can execute a collaborative filtering model to determine a first recommendation score 510 for the new item based on the historical user interactions with the one or more existing items. The first recommendation score can indicate a likelihood of the new item being accepted by users, which is determined by the collaborative filtering model.

The recommendation system can execute an adaptive model 512 to determine a second recommendation score for each new item. The second recommendation score can indicate a likelihood of the new item being accepted by users, which is determined by the adaptive model. For an initial period of time, the adaptive model may make recommendations for new items with less accuracy due to lack of training data. The recommendation system can make recommendations based on both the collaborative filtering model and the adaptive model 514. The recommendation system can output a first set of new items based on the first recommendation score for each new item and a second set of new items based on the second recommendation score for each new item.

During an iterative process, the recommendation system can keep outputting the recommended new items, and collecting the user interactions. For example, in each iteration, the recommendation system can make a set of new item recommendations and collect the user interactions for those new items. The recommendation system can add newly collected user interaction data to the training data and retrain the adaptive model. The prediction accuracy of the retrained adaptive model increases during the iterative process. In each iteration, the recommendation system can determine a first accuracy for the collaborative filtering model based on the user interactions to the first set of new item, and a second accuracy for the adaptive model based on user interactions to the second set of new items. In each iteration, the recommendation system can determine whether a ratio between the collaborative filtering model's accuracy and the adaptive model's accuracy satisfies a threshold 516. For example, the accuracy ratio is compared with the threshold value “1.”

If the accuracy ratio is less than 1, the accuracy of the collaborative filtering model is less than the accuracy of the adaptive model. Because the accuracy of the retrained adaptive model provides a higher accuracy, the recommendation system can transition to the adaptive model 520. The recommendation system can output new items only using the retrained adaptive model to make recommendations for the new items.

If the accuracy ratio is not less than one, the accuracy of the collaborative filtering model is equal to or larger than the accuracy of the adaptive model. Because the accuracy of the adaptive model is not higher than the accuracy of the collaborative filtering model, the recommendation system can keep using both models 518.

The order of steps in the process 500 described above is illustrative only, and the process 500 can be performed in different orders. In some implementations, the process 500 can include additional steps, fewer steps, or some of the steps can be divided into multiple steps.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”) (e.g., the Internet).

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method for providing recommendations from a computer-implemented recommendation system using a machine learning (ML) model, the method comprising:
obtaining a plurality of item profiles for a plurality of new items, each item profile comprising a set of attributes for a respective new item;
for each new item in the plurality of new items:
selecting one or more existing items that are similar to the new item based on item attributes of the one or more existing items and the set of attributes of the new item, and
executing a collaborative filtering model to determine a first score for the new item based on historical user interactions with the one or more existing items;
determining a second score for each new item in the plurality of new items using an adaptive model; and
outputting a first set of new items based on the first score, and a second set of new items based on the second score, wherein an initial ratio between the first set of new items and the second set of new items is a predetermine value.

2. The computer-implemented method of claim 1, comprising:
determining a first accuracy based on user interactions to the first set of new items and a second accuracy based on user interactions to the second set of new items; and
in response to determining that an accuracy ratio between the first accuracy and the second accuracy satisfies a threshold, outputting new items only using the adaptive model.

3. The computer-implemented method of claim 2, wherein the second accuracy corresponds to the adaptive model and the second accuracy increases during an iterative process.

4. The computer-implemented method of claim 1, comprising, in an iterative process:
collecting user interactions to the first set of new items and the second set of new items;
training the adaptive model using the user interactions to the first and the second set of new items;
updating the second score for each new item using the trained adaptive model; and
updating and outputting the first set of new items and the second set of new items based on the first score and the updated second score.

5. The computer-implemented method of claim 4, wherein a ratio between the updated first set of new items and the updated second set of new items is less than the initial ratio.

6. The computer-implemented method of claim 4, wherein training the adaptive model using the user interactions to the first and the second set of new items in the iterative process comprises:
for a threshold number of iterations, collecting user interactions to the first set of new items and the second set of new items; and
training the adaptive model using the user interactions collected in the threshold number of iterations.

7. The computer-implemented method of claim 1, wherein the one or more existing items are selected based on an adjusted cosine similarity.

8. The computer-implemented method of claim 7, wherein the adjusted cosine similarity is determined based on the set of attributes of the new item, the item attributes of the one or more existing items, and historical user interactions to the one or more existing items.

9. The computer-implemented method of claim 1, wherein the new item comprises one of a new item and a new action.

10. One or more non-transitory computer-readable storage media coupled to one or more processors and having instructions stored thereon which, when executed by the one or more processors, cause the one or more processors to perform operations for providing recommendations from a computer-implemented recommendation system using a machine learning (ML) model, the operations comprising:
obtaining a plurality of item profiles for a plurality of new items, each item profile comprising a set of attributes for a respective new item;
for each new item in the plurality of new items:
selecting one or more existing items that are similar to the new item based on item attributes of the one or more existing items and the set of attributes of the new item, and
executing a collaborative filtering model to determine a first score for the new item based on historical user interactions with the one or more existing items;
determining a second score for each new item in the plurality of new items using an adaptive model; and
outputting a first set of new items based on the first score, and a second set of new items based on the second score, wherein an initial ratio between the first set of new items and the second set of new items is a predetermine value.

11. The one or more non-transitory computer-readable storage media of claim 10, wherein the operations comprise:
determining a first accuracy based on user interactions to the first set of new items and a second accuracy based on user interactions to the second set of new items; and
in response to determining that an accuracy ratio between the first accuracy and the second accuracy satisfies a threshold, outputting new items only using the adaptive model.

12. The one or more non-transitory computer-readable storage media of claim 10, wherein the operations comprise, in an iterative process:
collecting user interactions to the first set of new items and the second set of new items;
training the adaptive model using the user interactions to the first and the second set of new items;
updating the second score for each new item using the trained adaptive model; and
updating and outputting the first set of new items and the second set of new items based on the first score and the updated second score.

13. The one or more non-transitory computer-readable storage media of claim 12, wherein training the adaptive model using the user interactions to the first and the second set of new items in the iterative process comprises:
for a threshold number of iterations, collecting user interactions to the first set of new items and the second set of new items; and
training the adaptive model using the user interactions collected in the threshold number of iterations.

14. The one or more non-transitory computer-readable storage media of claim 10, wherein the one or more existing items are selected based on an adjusted cosine similarity.

15. The one or more non-transitory computer-readable storage media of claim 14, wherein the adjusted cosine similarity is determined based on the set of attributes of the new item, the item attributes of the one or more existing items, and historical user interactions to the one or more existing items.

16. A system, comprising:
one or more processors; and
a computer-readable storage device coupled to the one or more processors and having instructions stored thereon which, when executed by the one or more processors, cause the one or more processors to perform operations for providing recommendations from a computer-implemented recommendation system using a machine learning (ML) model, the operations comprising:
obtaining a plurality of item profiles for a plurality of new items, each item profile comprising a set of attributes for a respective new item;
for each new item in the plurality of new items:
selecting one or more existing items that are similar to the new item based on item attributes of the one or more existing items and the set of attributes of the new item, and
executing a collaborative filtering model to determine a first score for the new item based on historical user interactions with the one or more existing items;
determining a second score for each new item in the plurality of new items using an adaptive model; and
outputting a first set of new items based on the first score, and a second set of new items based on the second score, wherein an initial ratio between the first set of new items and the second set of new items is a predetermine value.

17. The system of claim 16, comprising:
determining a first accuracy based on user interactions to the first set of new items and a second accuracy based on user interactions to the second set of new items; and
in response to determining that an accuracy ratio between the first accuracy and the second accuracy satisfies a threshold, outputting new items only using the adaptive model.

18. The system of claim 16, comprising, in an iterative process:
collecting user interactions to the first set of new items and the second set of new items;
training the adaptive model using the user interactions to the first and the second set of new items;
updating the second score for each new item using the trained adaptive model; and
updating and outputting the first set of new items and the second set of new items based on the first score and the updated second score.

19. The system of claim 18, wherein training the adaptive model using the user interactions to the first and the second set of new items in the iterative process comprises:
for a threshold number of iterations, collecting user interactions to the first set of new items and the second set of new items; and
training the adaptive model using the user interactions collected in the threshold number of iterations.

20. The system of claim 16, wherein the one or more existing items are selected based on an adjusted cosine similarity.

21. The system of claim 20, wherein the adjusted cosine similarity is determined based on the set of attributes of the new item, the item attributes of the one or more existing items, and historical user interactions to the one or more existing items.
